(19) United States
(12) Patent Application Publication
(10) Pub. No.: US 2021/0233098 A1
(43) Pub. Date: Jul. 29, 2021

(54) Method and device to inform a customer of the carbon dioxide emission for off and online purchasing of goods and services with credit debit or prepaid cards

(71) Applicant: Elke Unbehaun, Frankleben (DE)

(72) Inventor: Elke Unbehaun, Frankleben (DE)

(21) Appl. No.: 16/750,016

(22) Filed: Jan. 23, 2020

(51) Int. Cl. G06Q 30/02; G06Q 20/12; G06Q 50/26

(52) U.S. Cl. CPC G06Q 30/0213; G06Q 50/26; G06Q 20/12; G06Q 30/0222

(57) ABSTRACT

Method and device for carbon dioxide emission information and/or compensation by a customer, which comprises utilizing a discount system integrated in a card scheme; and calculating a value by multiplying a price by a factor related to a Merchant Category Code (MCC), whereby the rounded value used is lesser than or equal null, optionally the value is always negative.

### FIELD OF THE INVENTION

The invention relates to a method and device to inform a customer of the carbon dioxide emission for purchasing, especially on off- & on-line shopping using financial services for payment with credit cards. A further aspect is the optional possibility for automatically compensation this emission by a customer.

### BACKGROUND OF THE INVENTION

There are some financial services corporations using cards, especially credit cards, debit cards and prepaid cards, issued by issuing members. The U.S. Pat. No. 6,507,823B1 discloses a system and method for on-line purchasing of goods and services, especially a method of conducting a financial transaction between a purchaser and a vendor of a product (goods and/or services), the purchaser and the vendor each having an account held at respective first and second financial institutions. The method requires the provision of at least one vendor database including product-related information, for example regarding the availability and price of a product. A publicly accessible data exchange terminal, typically an automatic teller machine (ATM) or a web application running on a desktop or mobile device, is linked to the vendor database. The system then interrogates the purchaser to obtain transaction-related information via the terminal by requiring the purchaser to indicate a number of transaction options. The terminal is linked to the first financial and second financial institutions to provide access to the purchaser's and vendor's accounts. The system then transfers funds electronically between accounts for the value of the transaction. Of course, the first and second financial institutions may be the same financial institution.

In general Card schemes are payment networks linked to payment cards, such as debit or credit cards, of which a bank or any other eligible financial institution can become a member. The U.S. Pat. No. 5,397,882A discloses a Card Linked Offer whereby each customer who wishes to make use of the self-registration system must possess a customer pass in the form of a credit card to calculate the total price of the selected articles, taking into account any discounts, promotional prices and the like. The U.S. Pat. No. 8,833,645B2 discloses a method for automatically calculating discounts for purchases from merchants. The determined discounts have as generally positive signs, such as a discount factor of {+0.1,+0.025,+0.0001} to multiply with a price of a product bought.

Further there exist some classification systems related to goods and services, such as the “Nice Agreement Concerning the International Classification of Goods and Services for the Purposes of the Registration of Marks” (NC) for the goods and services, consisting of 34 respectively 11 class headings, explanatory notes, and an alphabetical list of goods and services. The alphabetical list is an alphabetized enumeration of about 10,000 goods and about 1,000 services, official translated into about all languages currently used worldwide. Similar but more suitable for computation the similar Merchant Category Code (MCC) is a four-digit number retail financial services used to classify a business by the types of goods or services it provides. An MCC reflects the primary category in which a merchant does business and may be used: to determine the interchange fee paid by the merchant, by credit card companies to offer cash back rewards or reward points, by card networks to define rules and restrictions for card transactions and for tax purposes.

The current worldwide economic system is based on steady increasing production and consumption of food, fuels, manufactured goods, materials, wood, roads, buildings, transportation and other services, in the following short goods and services, payable in money. But by physical reasons producing goods and consuming services needs energy and base materials each. Because our current primary energy production is to over 90% based on firing carbon comprising coal, oil and natural gas there is a strong correlation between energy and carbon dioxide (CO2) produced during a whole lifecycle of a given good or service, namely the “Carbon footprint”—a measure for the Carbon Dioxide Equivalent (CDE). CO2 in Earth's atmosphere is a greenhouse gas, potentially responsible for a climate change in the next decades with increasing temperatures of about five degree (mean value). Also increasing atmospheric CO2 concentrations lead to further acidification of the grounds and oceans and thus potentially destroy the livelihood of some plants and animals. Therefore a lot of people quarrel with their personal kind of lifestyle having too much consumption of goods and services and earn a guilty conscience, believers fear further disadvantages in their next life and lovely parental, feeling responsible for the “pursuit of happiness” of their children, now try to compensate their personal legacy of a earth plundered by their selves with paying of innovative projects to save the climate, i.e. digging a lot of sinkholes to water the desserts, revegetation them and finally cool the Earth's atmosphere down again but some hundred years later. The positive environmental and social impact a carbon dioxide compensation has on developing countries and the way it produces green energy may be a first step towards stopping global warming. US Published Patent Application 2006/0095356 discloses a system and method eliminating the need for extensive data input by using the Manufacturer Category Code (MCC) as the basis for a carbon emission estimate. As the MCC is routinely generated and communicated in standard credit card and debit card transactions, the method does not require any additional data input. The system comprises a database containing groupings of MCCs, with an average carbon emission value per country specific local currency for each grouping. The carbon emission associated with a credit card transaction can be calculated by multiplying the dollar value of the transaction with a factor representing the MCC of the transaction.

The British patent application GB2470216A discloses a method of calculating the carbon footprint associated with a purchase transaction, such as fuel, petrol or airline ticket, comprising obtaining transaction details comprising at least an identification of the merchant, and the amount of the transaction, using the MCC as the basis for a carbon emission estimate and grafted onto an existing credit card payment infrastructure. The system of U.S. Pat. No. 7,818,227B2 converts the MCC to an emission category, from which an emission factor is determined from a look-up table. The emission factor is multiplied by the dollar amount of the transaction to provide the CO2 emission, in lbs or kg.

The U.S. Pat. No. 7,426,489B2 discloses a system and method of for the banking and trading of emissions reductions credits (ERC's) and a computer site therefore utilizes a global communication network to trade ERC's. Certain variables are user-selectable to choose a specific reduction type (solar thermal, photo voltaic, microhydro, etc.) and a particular country where the system is located. The customer reads and accepts the terms of trading on the exchange, including fees and any percentages that may apply, such as the point of sale system provides the volume of gasoline and customer identification to the provider platform and provides the volume of gasoline, price and other details to the club/credit card customer, using the internet to view emission reductions attached to gasoline purchases. The gasoline program administrator manages the reduction portfolio and the gasoline buyers use report functions to inform reduction purchases to relevant authority. To use this method the club/credit card customer has to agree the terms of trading on any exchange for ERC's, which is costly.

Thus the goal of the present invention is to inform a (credit, debit or prepaid) card customer of the carbon dioxide emission caused by a purchase (goods and/or services) in a simple way without further costs. A further aspect of the present invention is to simplify the way for customers willing to compensate their CO2 emitting purchase of a product, especially without costly trading on any exchange for ERC's.

This problem is solved by the combination of all features of the independent claims each. Advantageous improvements are subject of the dependent claims each.

### BRIEF SUMMARY OF THE INVENTION

The object of the present invention is a method and device for carbon dioxide emission information and/or compensation by a customer, which comprises utilizing a discount system integrated in a (credit, debit or prepaid) card scheme, calculating a (discount) value by multiplying a price by a factor related to a MCC (of the merchant or merchant category), whereby the (commercial or bankers') rounded (discount)value used (as discount) is lesser than or equal null, optionally the (discount) value is always negative.

By this solution for carbon dioxide emission information and/or compensation by a customer any worldwide accepted (credit, debit or prepaid) card scheme is usable without any changing on it. The discount system integrated in a (credit, debit or prepaid) card scheme of a financial service for purchasing and payment is used in a unusual way to describe an (emission) amount related to the carbon emission of the product bought. This method is running on an ATM, or a web application running on a desktop or mobile device. Thus the (credit, debit or prepaid) card customer is automatically informed about the carbon dioxide emission (in lbs or kg) caused by the purchase.

Advantageous the method is comprising the stages:

(i) a (carbon emission compensation) organization, holding a (discount) contract with a financial service, which includes the discount system, sets at the financial service an information text module and the at least one (discount) factor for the related MCC of a merchant or merchant category, holding a membership on the organization;

(ii) the customer, holding a (credit, debit or prepaid) card of the financial service and a membership on the organization, enters a shop (online or offline);

(iii) the shop offers a product (goods and/or services) with the MCC of the merchant or merchant category;

(iv) the customer buys a quantity of the product for a price offered by the shop;

(v) the costumer chooses to pay the price for the product bought using the card of the financial service;

(vi) the financial service receives from the shop at least the price and the MCC of the purchased product;

(vii) the financial service determines a value for the customer, using at least the price, the MCC and the factor related to the MCC;

(viii) the financial service creates an information text (including the value in a converted manner) to describe an (emission) amount related to the carbon emission of the product bought, using at least the information text module and the value.

Thus using the information text including the calculated value in a converted manner the customer is informed from the financial service for carbon dioxide emission of the product bought by a view on the card-account, by an agreed Short Message Service (SMS) push notification after each purchase or at the latest by a (mandatory) monthly statement.

Advantageous the method is comprising the additional stages:

(ix) the financial service sends an order to pay, including the information text, to the customer;

(x) the costumer confirms or declines the order to the financial service;

(xi) only in the confirming case a banking account of the customer related to the card used is debited with the order by the financial service.

Thus the customer is informed from the financial service by the information text for carbon dioxide emission of the product bought before the buying process is finished and the card used is debited with the order by the financial service.

Advantageous the method is comprising:

in step (vii) the absolute factor is lesser than 0.5% divided by a maximal disposal limit of the financial service for paying by card in a currency used;

in step (viii) for formatting the value, calculated by multiplying the price by the factor, is multiplied by a (scaling) parameter included in the information text module, suitable for converting the value into a (common unit of the) amount;

in step (ix) the order to pay further includes a discount for the customer, calculated by multiplying the price by the factor, whereby the discount is commercial or bankers' rounded to (at most) an epsilon <1% of the currency used.

Thus the epsilon-like (discount) factor is used for calculating the an (emission) amount related to the carbon emission of the product bought, but the commercial or bankers' rounded discount to an epsilon smaller than 1/100 of the currency used (smallest coin) for the customer yields always null and thus the order to pay is equal to the (original) price as offered by the shop. Further common Card Linked Offers integrated in a (credit, debit or prepaid) card scheme of a financial service for purchasing and payment is usable. This epsilon-like factor is possible without changes in computational hardware and software because for financial purposes generally all variables needed are floating-point numbers, allowing very small numbers. Thus only the information about the amount related to the carbon emission is displayed usable for information purposes of the costumer only, without any further costs.

Another advantageous embodiment is comprising:

in step (i) the organization further sets a banking account at the financial service and the factor has negative sign;

in step (viii) for formatting the value, calculated by multiplying the price by the factor, is multiplied by a (scaling) parameter included in the information text module, suitable for converting the value into a (common unit of the) amount;

in step (ix) the order to pay further includes a (negative) discount for the customer, calculated by multiplying the price by the factor, whereby the discount is commercial or bankers' rounded to (at least) 1% of the currency used;

after step (xi) in an additional step (xii) only in the confirming case the financial service transfers at least a part of the absolute value of the discount to the banking account of the organization.

Thus the (credit, debit or prepaid) card customer is automatically informed about the carbon dioxide emission (in lbs or kg) caused by the purchase, before the card used is debited with the order reduced by the (negative) discount by the financial service to compensate this carbon dioxide emission without any additional costs except the ordered compensation occur. This negative factor is possible without changes in computational hardware and software because for financial purposes generally all variables needed are floating-point numbers, supporting both signs.

Advantageous the information of the order shown to the costumer includes an offer of a reward, given in the name of the costumer to the organization. Thus by confirmation of the costumer in step (x) additionally an (one sided) contract is signed, such as the costumer offers some services in a given scope of services to a given third party to enable the customer to compensate his CO2 emission alternatively to at least partially compensate the product bought.

Advantageous the reward includes an agreement for an irrevocable, unrestricted, non-transferable obligation of the costumer personally. Thus this reward is freely negotiable to a further third party, such as to those sized in foreign counties related to the size of the organization and/or the costumer.

Advantageous before confirming the order of the financial service in step (x) the costumer is asked to enter an additionally input related to the product bought, optionally the input is transmitted to the organization, further optionally only statistical results without personal data. Such as if the product is a flight some input related the length of flight, if the costumer is a carnivore or a vegetarian or other information like age or county of living. Thus in later doubts about the reward at least the determined amount is able to judge to be right, using this input and further the organization is able to adjust the amounts accordingly based on statistics available for different customer groups.

Advantageous the factor for determining the amount (of CO2 emission) in stages (vii, viii) is determined either at a bank or a trusted authority, holding an agreement with the organization. Thus based by the huge size of them a statistically trusted determining of the factor and thus also of the amount determined using this is guaranteed.

Another object of the present invention is a device, an automatic teller machine, or a desktop or mobile device running a web application or a mobile device running a mobile application, comprising:

one or more processors;

an input device adapted to receive an input from a customer and to provide the input to the one or more processors;

an output device adapted to receive an output from the one or more processors and and to provide the output to the customer;

a clock, used by the processor to execute an instruction step by step; and

a memory, storing the instruction,

whereby the instruction is carry out the method described above.

Thus this method is usable from most of all costumers about anywhere on the earth.

An advantageous system usable to inform the customer of the carbon dioxide emission for off- & on-line purchasing of goods and services with credit, debit or prepaid cards comprises a combination of at least above described method and device.

### DETAILED DISCLOSURE OF THE INVENTION

Four examples of some preferred embodiments of the invention will be fully described here. It will be understood that the principles described in this example can be applied to purchases of any type, such as the card includes credit cards, debit cards, prepaid cards as so one.

In a first example an inventive system comprising a method for carbon dioxide emission information only and a device in form of an ATM integrated in an automated fuel dispenser for off-line purchasing of fuel, is described. This system comprises utilizing a discount system in form of a Card Linked Offer (CLO) integrated in a common Card scheme of a financial service, such as offered by the International Service Association (VISA).

The device used, an ATM integrated in an automated fuel dispenser for off-line purchasing of fuel usable from most of all costumers about anywhere on the earth, comprising: two processors, one for ATM and dispenser each; a minimalism display as output-device adapted to receive an output such as a numeric price from the two processors and to provide the output to the customer and a minimalism keyboard as input-device to receive an input such as a Personal Identification Number (PIN) entered by a customer and to provide the input to the two processors; a clock, used by the two processors to execute an instruction step by step; and a memory, storing the instruction. This instruction is carry out the following steps, limited to those stages of the method below to do by the ATM itself.

A costumer, who signed an agreement with an organization for CO2 compensation to be informed only about the carbon emission amount of products bought before, bought a single tank contents fuel for a Sport utility vehicle (SUV) used for driving around for fun only of a quantity of 100 liter gasoline at an automated fuel dispenser for a price to pay of 77 $ and paid it with VISA-card offered by costumers bank. To do this the costumer had also to sign agreements with booth the bank and VISA before. The Card Linked Offer integrated in the VISA Card scheme knows discount factor related to the MCC of 5542 calculated and given by an organization for CO2 compensation, holding an agreement with VISA. This MCC of 5542 and the price of 77 $ are also known by VISA from costumers single paying the fuel with VISA-card. The emission amount of one liter gasoline is 2.31 kg of CO2, thus costumers purchase of 100 liter gasoline yielded to an amount of carbon emission of 231 kg or about 3 kg CO2 a $. Trivial multiplying the price of 77 $ by a fictive possible discount factor of +3 would yield to the right CO2 amount but also to a relevant financial discount value of 231 $, but who's pay this discount? Therefore the factor really used by the inventive method to yield a discount value rounded by VISA to a discount of 0.00 $ without any financial relevance, for all possible prices to pay with VISA in $ lesser than the maximal disposal limit, has to be much smaller, i.e. 3*10\hat{ }(−100) within the boundaries for floating-point numbers implemented with single precision. Thus for the MCC of 5542 a discount factor of 3*10\hat{ }(−100) is calculated by the organization first and tabled by VISA in its discount system later. The discount system of VISA is usually calculating in $ a discount value of +231*10\hat{ }(−100) by multiplying the price of 77 by a factor of 3*10\hat{ }(−100) related to the MCC=5542 of the merchant category of gas stations using automated fuel dispensers for selling fuels in form of gasoline. The price to pay in $, credited by VISA first and has to balanced by the costumer later, is the price for the fuel purchased reduced by the commercial rounded discount value of 0.00, means 77.00−0.00=77.00 and thus the discount as such is not necessarily listed separately by the ATM when the costumer is paying the fuel with VISA-card. But the VISA account displayed on demand and at least the monthly VISA report verifiable by the costumer shows additional information text for each single purchase paid with the VISA-card, such as the payment of “77 $” for an “AFD” labeled automated fuel dispenser which sold the fuel some days before on “DD-MM-YY” and the additional information text “=>231 kg CO2”, whereby the included formatted value of “231” is the discount value of +231*10\hat{ }(−100) calculated by the discount system of VISA but multiplicative scaled by a fixed parameter of *10\hat{ }(+100) for formatting purposes. Thus the costumer is informed by VISA for carbon dioxide emission information. For this the discount system integrated in a card scheme of a financial service for purchasing and payment is used in a unusual way to describe an emission amount related to the carbon emission of the product bought.

The preferred method for the first example more detailed is comprising the stages:

(i) A carbon emission compensation organization labeled “CO2-inform”, holding a discount contract with VISA, which includes a VISA-specific discount system in form of a CLO labeled “V-CLO”. To inform the costumer labeled “Mr-C” about the CO2 emission amount related to costumers purchase paid by VISA-card “CO2-inform” sets at VISA a “CO2-inform”-specific information text module “=>&1 kg CO2” including a variable &1, output-formatted by a scaling parameter of 10\hat{ }(+100), and a table of the discount factor for the related MCC of a merchant or a merchant category, holding a membership on the “CO2-inform”, each. The information text module, scaling parameter, tabled discount factor and the related MCC on a “CO2-inform”-specific CO2-V-CLO-file are frequently transmitted from the “CO2-inform” to VISA. VISA itself frequently includes the data from the CO2-V-CLO-file to a VISA-specific V-CLO-file and transmits this to all supported ATMs, where it is stored in the application programming interface (API) of the Card scheme for offline purchasing. The merchant category of gas stations using automated fuel dispensers for selling fuels in form of gasoline has a MCC of 5542. “CO2-inform” knows from official databases the emission amount of one liter gasoline of 2.31 kg of CO2 and determined the MCC=5542 related discount factor to 3*10\hat{ }(−100).

(ii) “Mr-C” wants to fill up his Sport utility vehicle (SUV) used for driving around for fun only. “Mr-C” holding his VISA-card labeled “C-V-No.”, offered for VISA by his bank labeled “C-Bank”, and a membership on “CO2-inform”, enters a self-service petrol station with offline working automated fuel dispensers labeled “AFD”, holding a membership on “CO2-inform” via its mother petrol company.

(iii) “AFD” offers only one good as product, namely gasoline related with the MCC=5542 for a price to pay of 0.77 $ a liter (2.91 $ a gallon).

(iv) “Mr-C” fills up his SUV and thus he buys a single tank contents gasoline of 100 liter for 77 $ as offered by “AFD”.

(v) “Mr-C” chooses to pay the 77 $ for the gasoline bought using his VISA-card labeled “C-V-No.” to took part on the “V-CLO” discount system of VISA.

(vi) Since “Mr-C” paid with his own VISA-card “C-V-No.”, VISA receives the price to pay of 77 $ and the MCC=5542 related to the purchased gasoline from “AFD”.

(vii) VISA including its “V-CLO” determines for this payment the discount value for “Mr-C”, by multiply the price to pay of 77 $ by the factor 3*10\hat{ }(−100) related to the MCC=5542 to the (positive, but epsilon-like) discount value of +231*10\hat{ }(−100). The absolute factor of 3*10\hat{ }(−100) is lesser than 0.5% divided by a maximal disposal limit of VISA for paying by VISA-card in $. For “V-CLO” the commercial rounded discount value is 0.00 $, thus the price to pay of 77.00 $ is not to change, since x−0=x by mathematics.

(viii) Using the information text module “=>&1 kg CO2” and formatting the included variable &1 by scaling the determined discount value of +231*10\hat{ }(−100) with the fixed scaling parameter 10\hat{ }(+100), VISA creates an information text “=>231 kg CO2” to describe the emission amount related to the carbon emission of the gasoline bought by “Mr-C”. For formatting the discount value of +231*10\hat{ }(−100), calculated by multiplying the price of 77.00 $ by the factor of 3*10\hat{ }(−100), is multiplied by the scaling parameter of 10\hat{ }(+100), included as variable &1 in the information text module “=>&1 kg CO2”, suitable for converting the discount value into a common unit of the amount of carbon dioxide emission, namely “kg CO2”. This information text “=>231 kg CO2” is sent by VISA to “Mr-C”'s mobile device, because “Mr-C” agreed this with VISA before. Only in the case and after successfully paying “Mr-C” also will be able to read this information text when he is checking his VISA-account regarding his VISA-card “C-V-No.” anytime later on-line at an online ATM, a online desktop or smartphone and at the mandatory monthly statement of VISA. This information method works well also with as simple as possible offline ATMs.In the case the ATM used by “Mr-C” for paying is a more intelligent device with alphanumeric input/output-device such as a touchscreen, the preferred method for the first example more detailed is comprising also the additional stages:

(ix) VISA displays via the ATM to “Mr-C” at current date/time MM-DD-YY/HH:MM a V-CLO-specific order to pay, including the information text: “MM-DD-YY/HH:MM_77.00 $_AFD_=>231 kg CO2” or “MM-DD-YY/HH:MM_77.00 $_0.00 $_AFD_=>231 kg CO2” further including a reducing discount for “Mr-C”, calculated by multiplying the price to pay of 77.00 $ by the discount factor of 3*10\hat{ }(−100), whereby the discount of +231*10\hat{ }(−100) $ is commercial or bankers' rounded to 0.00 $<1% of the currency used of 0.01 $. Thus the epsilon-like discount factor of 3*10\hat{ }(−100) is used for calculating the emission amount of 231 kg CO2 related to the carbon emission of the gasoline bought, but the commercial or bankers' rounded discount of 0.00 $ to an epsilon smaller than 1/100 of one $ means one cent. Thus for “Mr-C” the discount yields always null and thus the order to pay is equal to the original price of 77.00 $ as offered by “AFD”. Using this epsilon-like factor of 3*10\hat{ }(−100) is possible without changes in computational hardware and software because for financial purposes generally all variables needed are floating-point numbers at least of single precision implemented by 4 bytes, allowing very small numbers.

(x) “Mr-C” chooses to confirm or decline the order to VISA via the ATM. In the declining case the method ends here.

(xi) Only in the confirming case “Mr-C”'s banking account of “C-Bank” related to the VISA-card “C-V-No.” used is debited with the confirmed order by VISA. Thus “Mr-C” is informed from VISA by the information text “MM-DD-YY/HH:MM_77.00 $_AFD_=>231 kg CO2” for carbon dioxide emission of the gasoline bought before the buying process is finished and the VISA-card “C-V-No.” used is debited with the order by VISA. Further common CLOs integrated in the card scheme of VISA for purchasing and payment is usable. Thus only the information about the amount of 231 kg CO2 related to the carbon emission is displayed usable for information purposes of “Mr-C” only, without any further costs.

In a second example a further inventive system comprising a method for carbon dioxide emission information including compensation and a device in form of a smartphone running an airline app offering the usage of a worldwide online payments system like PayPal based on cards, is described. This system comprises utilizing a discount system in form of a CLO integrated in a common Card scheme of a financial service, such as D-CLO offered by PayPal in the name of Diners Club International (DCI) for costumers using DCI-cards. The inventive method for information and compensation by a customer, which comprises utilizing a discount system integrated in a DCI-card scheme, calculating a negative discount value by multiplying a price to pay by a discount factor related to a MCC of the merchant or merchant category. Since a discount d used in a common CLO is reducing the price p to pay a negative one will increase it by mathematics p−(−d)=p+d. Done by the negative discount the costumer always has to pay more than the original price to pay—namely an additionally compensation for the amount of carbon dioxide emission related to the product bought by the costumer.

The device used in this second example, a smartphone suitable for running web-applications and mobile applications for secure on-line purchasing of goods and services usable from most of all costumers about anywhere on the earth, comprising: one processor acting as client in a client-server-systems, whereby the server is running in the environment of the payments system used; a touchscreen as booth an output-device adapted to receive an output such as a numeric price from the processor and to provide the output to the customer and an input-device to receive an input such as a PIN entered by a customer and to provide the input to the processor; a clock, used by the processor to execute an instruction step by step; and a memory, storing the instruction. This instruction is carry out the following steps, limited to those stages of the method below to do by the client or the server, whereby it is for understanding of this second example not necessary to distinguish between them as any skilled person knows.

Here the costumer pays a flight bought with DCI-card and compensate by one's own choice the amount of related carbon dioxide emission partly by both an additional paying and own service.

A preferred method of the second example is comprising the stages:

(i) A carbon emission compensation organization labeled “CO2-inform”, holding for DCI-card holders a discount contract with PayPal, holding a discount contract with DCI, which includes a DCI-specific discount system in form of a CLO labeled “D-CLO”. To inform/compensate the costumer labeled “Mr-C” about/for the CO2 emission amount related to costumers purchase paid by DCI-card “CO2-inform” sets at DCI a “CO2-inform”-specific information text module “=>&1 kg CO2” including a variable &1, output-formatted by a negative scaling parameter of (−5), and a table of the discount factor for the related MCC of a merchant or a merchant category, holding a membership on the “CO2-inform”, each. “CO2-inform” stores its own banking account labeled “CO2-bank”, the information text module, scaling parameter, tabled discount factor and the related MCC on a “CO2-inform”-specific CO2-D-CLO-file are frequently transmitted from the “CO2-inform” to DCI. DCI itself frequently includes the data from the CO2-D-CLO-file to a DCI-specific D-CLO-file and transmits this to PayPal, where it is stored in the API of the Card scheme for on-line purchasing using PayPal. The merchant category of airlines and air carriers has a MCC of 4511. “CO2-inform” knows from a database of a trusted authority, holding an agreement with “CO2-inform”, the discount factor of −0.12 related to the emission amount per passenger km flight in a usual bigger airplane of 0.12 kg of CO2 and determined using the MCC=4511. Thus a flight over a distance of 1000 km is related with an amount of 120 kg CO2. Further based by the huge size of the factor-database a statistically trusted determining of the discount factor and thus of the CO2 amout determined is guaranteed.

(ii) “Mr-C” wants to fly two short distances of 500 km each to/from a budget holiday destination. “Mr-C” holding his DCI-card labeled “C-D-No.”, offered for DCI by his bank labeled “C-Bank”, and a membership on “CO2-inform”, enters using his smartphone a web-based flying-portal labeled “FP”, holding a membership on “CO2-inform” via its contract with PayPal.

(iii) “FP” offers only one service as product, namely passenger-flights related with the MCC=for a price to pay of 200€ a as round trip, such as from Berlin to Paris and return in economy class.

(iv) “Mr-C” books this round trip and thus he buys two flights of 500 km each for 200€ as offered by “FP”.

(v) “Mr-C” chooses to pay the 200€ for the flights bought using PayPal, which is using his DCI-card labeled “C-D-No.”, to took part on the “D-CLO” discount system of DCI.

(vi) Since “Mr-C” paid with his own DCI-card “C-D-No.”, DCI first and later PayPal receives the price to pay of 200€ and the MCC =4511 related to the purchased flights from “FP”.

(vii) DCI including its “D-CLO” first and later also PayPal determines for this payment the negative discount value for “Mr-C”, by multiply the price to pay of 200€ by the factor −0.12 related to the MCC=4511 to the negative discount value of −24€ as additionally payment to compensate the amount of 120 kg CO2 in parts financially. The total payment is calculated to 200€−(−24€)=224€ because a negative discount is an additionally payment for “Mr-C”'s financially compensation.

(viii) Using the information text module “=>&1 kg CO2” and formatting the included variable &1 by scaling the determined discount value of −24 with the fixed scaling parameter −5, DCI creates an information text “=>120 kg CO2” to describe the emission amount related to the carbon emission of the flight bought by “Mr-C”. For formatting the discount value of −24, calculated by multiplying the price of 200€ by the negative discount factor of −0.12, is multiplied by the scaling parameter of −5, included as variable &1 in the information text module “=>&1 kg CO2”, suitable for converting the discount value into a common unit of the amount of carbon dioxide emission, namely “kg CO2”. This information text “=>120 kg CO2” is sent by DCI to “Mr-C”'s mobile device, because “Mr-C” agreed this with DCI before. Only in the case and after successfully paying “Mr-C” also will be able to read this information text when he is checking his PayPal or DCI-account regarding his DCI-card “C-D-No.” anytime later at the mandatory monthly statement of DCI, on-line at an online desktop or smartphone or at an online ATM, because common online ATMs enables the customers of a financial institution to perform financial transactions, particularly cash withdrawal from a banking account and obtaining account information.

(ix) “Mr-C”'s smartphone displays via the web-application of PayPal to “Mr-C” at current date/time MM-DD-YY/HH:MM a D-CLO-specific order to pay, including the information text:

“MM-DD-YY/HH:MM_200€−(−24€)_FP_=>120 kg CO2” including a negative reducing discount for “Mr-C”, calculated by multiplying the price to pay of 200€ by the discount factor of −0.12, whereby the negative discount of −24€ is bankers' rounded to −24€ with absolute |−24€|>1% of one €, means one cent of 0.01€. Thus the total payment is different from the original price to pay, means greater done by the additional financially CO2 compensation.

(x) “Mr-C” chooses to confirm or decline the order to PayPal via the smartphone. In the declining case the method ends here.

(xi) Only in the confirming case “Mr-C”'s banking account of “C-Bank” related to the DCI-card “C-D-No.” used is debited with the confirmed order of 224€ by DCI.

(xii) Only in the confirming case PayPal transfers 90% (without 10% service fee for PayPal) of 475 the absolute value of the discount of |−24=24€|, means 21.60€ to the “CO2-bank” of “CO2-inform”, mostly used by “CO2-inform” to support CO2 capturing projects.

Thus “Mr-C” is informed online from PayPal by the information text “MM-DD-YY/HH:MM_200€−(−24€)_FP_=>120 kg CO2” for carbon dioxide emission of the flight bought before the buying process is finished and the DCI-card “C-D-No.” used is debited with the order by DCI. Further common CLOs integrated in the card scheme of DCI for purchasing and payment is usable. Thus booth the information about the amount of 120 kg CO2 related to the carbon emission is displayed usable for information purposes of “Mr-C” and the partly financially compensation of 24€ of “Mr-C” is processed, without any further costs for “Mr-C”. Thus the costumer is informed by PayPal for carbon dioxide emission information and additionally debited to compensate these. For this the D-CLO as discount system is integrated in a DCI-card scheme used by PayPal for payment is used in a unusual way to describe an emission amount related to the carbon emission of the product bought. Thus the card customer is automatically informed about the carbon dioxide emission in kg CO2 caused by the purchase, before the card used is debited with the order reduced by the negative discount by the financial service to compensate this carbon dioxide emission without any additional costs except the ordered compensation occur. This necessary negative factor is possible without changes in computational hardware and software because for financial purposes generally all variables needed are floating-point numbers, supporting both signs.

A third example is based on the second example. Thus the explanation for the second example above, where “Mr-C” is partially financially compensate his CO2-amount is included here. Here “Mr-C” additional wants to do more than this, namely offering services in his own name.

To allow this personally support of CO2 capturing projects the information text: “MM-DD-YY/HH:MM200€−(−24€)_FP_=>120 kg CO2_=>Herewith the owner of DCI-card C-D-No. offers to CO2-inform the personally service to plant one tree a 10 kg CO2 free of charge, anywhere on the Earth by free choice of CO2-inform or its successors. +++ By confirming this order herewith additionally signed one-sided declared reward is an irrevocable, unrestricted, non-transferable personally obligation. +++”

of the order additionally displayed a pre-formulated one-sided contract in the name of “Mr-C”, which will sign and thereby set in force by confirming this order by “Mr-C”. This form of signing is admissable in each single case by the agreement between “Mr-C” and “CO2-inform” signed before. Thus “Mr-C” is informed online from PayPal by the information above, shown to “Mr-C” by the display of the smartphone, including an offer of a reward, given in the name of “Mr-C” to “CO2-inform”. Thus by confirmation of “Mr-C” in step (x) additionally an one-sided contract is signed, such as “Mr-C” offers some services in a given scope of services to a given third party to enable himself to compensate his CO2 emission of the flight bought at least partially by personal service. Further this reward is freely negotiable to a further third party, such as to those sized in foreign counties like Egypt related to the size of “CO2-inform” and/or the “Mr-C”.

A fourth example is based on the second example. Thus the explanation for the second example above, where “Mr-C” is partially financially compensate his CO2-amount is included here. Here “Mr-C” additional wants to do more than this, namely to improve the accuracy of the CO2 amounts by transmitting additional personal data to the “CO2-inform”.

To allow this before confirming the order of PayPal in step (x) “Mr-C” is asked by “FP” to enter some additionally input related to the product bought, means the flight such as input related the length of flight, if the costumer is a carnivore or a vegetarian or other information like age or county of living or his personal frequent-flyer no. This input is frequently transmitted from “FP” to “CO2-inform”, but only as statistical results without personal data of “Mr-C”. Thus in later doubts about the reward at least the determined amount is able to judge to be right, using this input and further the organization is able to adjust the amounts accordingly based on statistics available for different customer groups.

1. A Method for carbon dioxide emission information and/or compensation by a customer, which comprises:
utilizing a discount system integrated in a card scheme; and
calculating a value by multiplying a price by a factor related to a Merchant Category Code (MCC),
whereby the rounded value used is lesser than or equal null, optionally the value is always negative.

2. Method of claim 1, comprising the stages:
(i) an organization, holding a contract with a financial service, which includes the discount system, sets at the financial service an information text module and the at least one factor for the related MCC of a merchant or merchant category, holding a membership on the organization;
(ii) the customer, holding a card of the financial service and a membership on the organization, enters a shop;
(iii) the shop offers a product with the MCC of the merchant or merchant category;
(iv) the customer buys a quantity of the product for a price offered by the shop;
(v) the costumer chooses to pay the price for the product bought using the card of the financial service;
(vi) the financial service receives from the shop at least the price and the MCC of the purchased product;
(vii) the financial service determines a value for the customer, using at least the price, the MCC and the factor related to the MCC; and
(viii) the financial service creates an information text to describe an amount related to the carbon emission of the product bought, using at least the information text module and the value.

3. Method of claim 2, comprising the additional stages:
(ix) the financial service sends an order to pay, including the information text, to the customer;
(x) the costumer confirms or declines the order to the financial service; and
(xi) only in the confirming case a banking account of the customer related to the card used is debited with the order by the financial service.

4. Method of claim 3, whereby:
in step (vii) the absolute factor is lesser than 0.5% divided by a maximal disposal limit of the financial service for paying by card in a currency used;
in step (viii) for formatting the value, calculated by multiplying the price by the factor, is multiplied by a parameter included in the information text module, suitable for converting the value into an amount; and
in step (ix) the order to pay further includes a discount for the customer, calculated by multiplying the price by the factor, whereby the discount is commercial or bankers' rounded to an epsilon <1% of the currency used.

5. Method of claim 3, whereby:
in step (i) the organization further sets a banking account at the financial service and the factor has negative sign;
in step (viii) for formatting the value, calculated by multiplying the price by the factor, is multiplied by a parameter included in the information text module, suitable for converting the value into an amount;
in step (ix) the order to pay further includes a discount for the customer, calculated by multiplying the price by the factor, whereby the discount is commercial or bankers' rounded to 1% of the currency used; and
after step (xi) in an additional step (xii) only in the confirming case the financial service transfers at least a part of the absolute value of the discount to the banking account of the organization.

6. Method of claim 5, whereby the information of the order shown to the costumer includes an offer of a reward, given in the name of the costumer to the organization.

7. Method of claim 6, whereby the reward includes an agreement for an irrevocable, unrestricted, non-transferable obligation of the costumer personally.

8. Method of claim 3, whereby before confirming the order of the financial service in step (x) the costumer is asked to enter an additionally input related to the product bought, optionally the input is transmitted to the organization, further optionally only statistical results without personal data.

9. Method of claim 2, whereby the factor for determining the amount in stages (vii, viii) is determined either at a bank or a trusted authority, holding an agreement with the organization.

10. A device, an automatic teller machine, or a desktop or mobile device running a web application or a mobile device running a mobile application, comprising:
one or more processors;
an input device adapted to receive an input from a customer and to provide the input to the one or more processors;
an output device adapted to receive an output from the one or more processors and and to provide the output to the customer;
a clock, used by the processor to execute an instruction step by step; and
a memory, storing the instruction,
whereby the instruction is carry out the method of claim 1.
